(19) United States
(12) Patent Application Publication
(10) Pub. No.: US 2020/0216926 A1
(43) Pub. Date: Jul. 9, 2020

(54) AMORPHOUS ALLOY RIBBON AND METHOD FOR MANUFACTURING SAME

(71) Applicants: HITACHI METALS, LTD., Minato-ku, Tokyo (JP); METGLAS INC., Conway, SC (US)

(72) Inventors: Naoki ITO, Conway, SC (US); Daichi AZUMA, Minato-ku, Tokyo (JP)

(73) Assignees: HITACHI METALS, LTD., Minato-ku, Tokyo (JP); METGLAS INC., Conway, SC (US)

(21) Appl. No.: 16/626,459

(22) PCT Filed: Jul. 3, 2018
(86) PCT No.: PCT/JP2018/025279

§ 371 Date: Dec. 24, 2019

Related U.S. Application Data
(60) Provisional application No. 62/528,451, filed on Jul. 4, 2017.

(51) Int. Cl. C21D 9/52; C21D 6/00; C22C 45/02; H01F 1/153

(52) U.S. Cl. CPC C21D 9/52; C21D 6/008; C22C 2202/02; H01F 1/15308; C22C 45/02

(57) ABSTRACT

A method of producing an amorphous alloy having a composition of Fe_{100-a-b}BₐSi_{b}C_{c} (13.0 atom %≤a≤16.0 atom %, 2.5 atom %≤b≤5.0 atom %, 0.20 atom %≤c≤0.35 atom %, and 79.0 atom %≤(100−a−b)≤83.0 atom %) includes: preparing an alloy ribbon; and, in a state in which the alloy ribbon is tensioned with a tensile stress of from 20 MPa to 80 MPa, increasing a temperature of the alloy ribbon to from 410° C. to 480° C., at an average temperature increase rate of from 50° C./sec to less than 800° C./sec, and decreasing a temperature of the thus heated alloy ribbon to a temperature of a heat transfer medium for temperature-decreasing, at an average temperature decrease rate of from 120° C./sec to less than 600° C./sec.

### TECHNICAL FIELD

The present disclosure relates to an amorphous alloy ribbon and a method of producing the same.

### BACKGROUND ART

Silicon steels, ferrites, Fe-based amorphous alloys, and Fe-based nanocrystalline alloys are known as magnetic materials of cores that are used in, for example, transformers, reactors, choke coils, motors, noise suppression components, laser power sources, pulse power magnetic components for accelerators, and power generators.

As the cores, for example, toroidal cores (wound cores), which are produced using an Fe-based amorphous alloy or an Fe-based nanocrystalline alloy, are known (see, for example, Patent Documents 1 and 2).

Amorphous alloys are generally produced by a single roll method having excellent productivity. In the single roll method, a cooling roll whose outer peripheral surface is composed of a copper alloy having excellent thermal conductivity is rotated at a high speed, and a molten alloy is discharged and rapidly solidified on the outer peripheral surface of the cooling roll, whereby a cast alloy ribbon can be obtained.

In the single roll method, after the initiation of casting of an amorphous alloy ribbon, the cooling roll may be thermally deformed due to the heat released from the molten alloy, and this may cause the distance between a discharge nozzle and the outer peripheral surface of the cooling roll to be different between a central portion and edge portions of the amorphous alloy ribbon in the width direction. Therefore, it is difficult to maintain the amorphous alloy ribbon to have a uniform thickness along the width direction. In addition, a phenomenon in which the casting-direction (longitudinal) length of the amorphous alloy ribbon varies between the central portion and the edge portions in the width direction, specifically a phenomenon that the longitudinal length is slightly longer in the ribbon widthwise ends than in the central portion, occurs. In this case, an undulating non-flat shape (also referred to as “side waves” or “edge waves”) appears in the edge portions of the alloy ribbon.

In association with these circumstances, a technology for performing a process of winding an amorphous alloy thin ribbon while modifying the widthwise peripheral length of an iron-cored winding reel in accordance with the degree of flatness of the amorphous alloy thin ribbon has been disclosed (see, for example, Patent Document 3).

Patent Document 1: Japanese Patent Application Laid-Open (JP-A) No. 2006-310787

Patent Document 2: International Publication (WO) No. 2015/046140

Patent Document 3: Japanese Patent Application Laid-Open (JP-A) No. S61-226909

### SUMMARY OF THE INVENTION

### Technical Problem

As described above, in the process of producing an Fe-based amorphous alloy ribbon, a non-flat shape such as an undulating shape (side waves or edge waves) is likely to appear in the widthwise ends of the resulting amorphous alloy ribbon.

However, it is difficult to make a mechanical correction due to a high Vickers hardness of a material used in the amorphous alloy ribbon. In other words, it is difficult to improve the degree of flatness of the amorphous alloy ribbon. Patent Document 3 discloses a technology that takes into consideration the degree of flatness of an amorphous alloy thin ribbon; however, it offers no disclosure with regard to improvement in the degree of flatness of the thin ribbon itself.

As described above, it has been considered difficult to flatten (improve the degree of flatness of) a non-flat shape such as an undulating shape (also referred to as “side waves” or “edge waves”) that appears in the widthwise ends of an amorphous alloy ribbon.

When a wound magnetic core is produced by winding an amorphous alloy ribbon, such an undulating shape is gradually accumulated in the widthwise ends of the amorphous alloy ribbon as the number of winding operations increases, and this makes wrinkles more likely to be formed. Therefore, it was difficult to produce a magnetic core shape with good reproducibility.

The present disclosure was made in view of the above-described circumstances.

An object of the embodiments of the present disclosure is to provide an amorphous alloy ribbon having excellent flatness, and a method of producing the same.

### Solution to Problem

In order to solve the above-described problems, it was found that an amorphous alloy ribbon having an improved shape with excellent flatness is obtained by performing a specific thermal treatment on an amorphous alloy in a state where the amorphous alloy is tensioned with a specific tensile stress. In addition, it was found that embrittlement caused by the thermal treatment is suppressed by performing the thermal treatment under specific conditions for temperature-increasing and temperature-decreasing.

The present disclosure is based on these findings, and concrete means thereof include the following aspects.

<1> A method of producing an amorphous alloy ribbon having a composition represented by the following Compositional Formula (A), the method comprising:

preparing an amorphous alloy ribbon having a composition consisting of Fe, Si, B, C, and unavoidable impurities;

increasing a temperature of the amorphous alloy ribbon to a target maximum temperature that is in a range of from 410° C. to 480° C., at an average temperature increase rate of from 50° C./sec to less than 800° C./sec, in a state in which the amorphous alloy ribbon is tensioned with a tensile stress of from 20 MPa to 80 MPa; and

decreasing a temperature of the thus heated amorphous alloy ribbon from the target maximum temperature to a temperature of a heat transfer medium for temperature-decreasing, at an average temperature decrease rate of from 120° C./sec to less than 600° C./sec, in a state in which the amorphous alloy ribbon is tensioned with a tensile stress of from 20 MPa to 80 MPa.

Fe_{100-a-b}BₐSi_{b}C_{c} Compositional Formula (A):

In Compositional Formula (A), a and b each represent an atomic fraction in the composition and satisfy the following respective ranges, and c represents an atomic fraction of C with respect to a total of 100.0 atom % of Fe, Si and B, and satisfies the following range:

13.0 atom %≤a≤16.0 atom %,

2.5 atom %≤b≤5.0 atom %,

0.20 atom %≤c≤0.35 atom %, and

79.0 atom %≤(100−a−b)≤83.0 atom %.

<2> The method of producing an amorphous alloy ribbon according to <1>, wherein the average temperature increase rate is from 60° C./sec to 760° C./sec, and the average temperature decrease rate is from 190° C./sec to 500° C./sec.

<3> The method of producing an amorphous alloy ribbon according to <1> or <2>, wherein the tensile stress is from 40 MPa to 70 MPa.

<4> The method of producing an amorphous alloy ribbon according to any one of <1> to <3>, wherein the (100−a−b) satisfies the following range:

80.5 atom %≤(100−a−b)≤83.0 atom %.

<5> The method of producing an amorphous alloy ribbon according to any one of <1> to <4>, wherein the increase of temperature in the temperature increasing step and the decrease of a temperature in the temperature decreasing step is performed by allowing the amorphous alloy ribbon to travel in a tensioned state and bringing the amorphous alloy ribbon that is traveling into contact with a heat transfer medium.

<6> The method of producing an amorphous alloy ribbon according to <5>, wherein a contact surface of the heat transfer medium that increases the temperature of the amorphous alloy ribbon that is traveling and a contact surface of the heat transfer medium that decreases the temperature of the amorphous alloy ribbon that is traveling are arranged in a flat plane.

<7> An amorphous alloy ribbon, comprising undulations at one widthwise end and at an opposite widthwise end, wherein a height h and a width w satisfy the following Equation (1):

0.1≤100×h/w≤1.5 Equation (1):

wherein the height h is an average value of plural heights including: heights of protruding apexes of undulations disposed at a position 10 mm away from, in an in-plane direction, the one widthwise edge of the amorphous alloy ribbon; and heights of protruding apexes of undulations disposed at a position 10 mm away from, in the in-plane direction, the opposite widthwise edge of the amorphous alloy ribbon, and the width w is an average value of width of the undulations.

According to the embodiments of the present disclosure, an amorphous alloy ribbon having excellent flatness, and a method of producing the same are provided.

### BRIEF DESCRIPTION OF DRAWINGS

FIG. 1 shows an appearance photograph of an amorphous alloy ribbon 1 according to the present disclosure that has been heat-treated at a target maximum temperature of 460° C., and an appearance photograph of an amorphous alloy ribbon 2 that is before being heat-treated and has a non-flat shape in which plural undulating shapes undulating in the thickness direction (the direction perpendicular to the ribbon main surface) are formed along the longitudinal direction in the vicinity of the widthwise edges, which appearance photographs were taken from the direction perpendicular to the main surface of each ribbon;

FIG. 2 is a schematic perspective view for describing the undulating shapes formed in the vicinity of the widthwise edges of an amorphous alloy ribbon;

FIG. 3 is a schematic drawing that views undulations 122 of the amorphous alloy ribbon illustrated in FIG. 2 from the direction of an arrow Z;

FIG. 4 is a schematic cross-sectional view illustrating one example of an in-line annealing apparatus used for the production of an amorphous alloy ribbon;

FIG. 5 is a schematic plan view illustrating a heat transfer medium of the in-line annealing apparatus illustrated in FIG. 4;

FIG. 6 is a cross-sectional view taken along a line III-III of FIG. 5; and

FIG. 7 is a schematic plan view illustrating a modification example of the heat transfer medium.

### DESCRIPTION OF EMBODIMENTS

### Mode for Carrying Out the Invention

The amorphous alloy ribbon of the present disclosure and a method of producing the same will now be described in detail.

In the present specification, those numerical ranges provided by the expression of “from . . . to . . . ” each denote a range that includes the numerical values stated before and after “to” as the lower limit value and the upper limit value, respectively. In the numerical ranges described in a stepwise manner in the present specification, the upper limits or the lower limits described in certain numerical ranges may be replaced with the upper limits or the lower limits in other numerical ranges described in a stepwise manner. Further, in the numerical ranges described in the present specification, the upper limits or the lower limits described in certain numerical ranges may be replaced with values described in examples.

Further, the term “step” used herein encompasses not only discrete steps but also steps that cannot be clearly distinguished from other steps, as long as the intended purpose of the step is achieved.

The term “amorphous alloy ribbon” used herein means an elongated alloy ribbon.

A method of producing the above-described amorphous alloy ribbon of the present disclosure is a method by which an amorphous alloy ribbon having a composition represented by the following Compositional Formula (A) is produced using an amorphous alloy ribbon that has a composition including Fe, Si, B, C and unavoidable impurities (hereinafter also referred to as an “alloy ribbon”), the method including: preparing an amorphous alloy ribbon having a composition consisting of Fe, Si, B, C, and unavoidable impurities (this step is hereinafter also referred to as a “ribbon preparation”); increasing a temperature of the amorphous alloy ribbon to a target maximum temperature that is in a range of from 410° C. to 480° C., at an average temperature increase rate of from 50° C./sec to less than 800° C./sec, in a state in which the amorphous alloy ribbon is tensioned with a tensile stress of from 20 MPa to 80 MPa (this step is hereinafter also referred to as a “temperature-increasing”); and decreasing a temperature of the thus heated amorphous alloy ribbon from the target maximum temperature to a temperature of a heat transfer medium for temperature-decreasing, at an average temperature decrease rate of from 120° C./sec to less than 600° C./sec, in a state in which the amorphous alloy ribbon is tensioned with a tensile stress of from 20 MPa to 80 MPa (this step is hereinafter also referred to as a “temperature-decreasing”).

Fe_{100-a-b}BₐSi_{b}C_{c} Compositional Formula (A):

In Compositional Formula (A), a and b each represent an atomic fraction in the composition and satisfy the following respective ranges, and c represents an atomic fraction of C with respect to a total of 100.0 atom % of Fe, Si and B, and satisfies the following range:

13.0 atom %≤a≤16.0 atom %,

2.5 atom %≤b≤5.0 atom %,

0.20 atom %≤c≤0.35 atom %, and

79.0 atom %≤(100−a−b)≤83.0 atom %.

Details of the amorphous alloy ribbon having a composition represented by Compositional Formula (A) are described below.

<Ribbon Preparation>

The method of producing an amorphous alloy ribbon according to the present disclosure includes a step of preparing an amorphous alloy ribbon that has a composition including Fe, Si, B, C, and unavoidable impurities.

An amorphous alloy ribbon can be produced by a known method, such as a liquid quenching method in which a molten alloy is ejected onto an axially-rotating cooling roll.

The step of preparing an amorphous alloy ribbon is not necessarily required to be a step of producing an amorphous alloy ribbon, and may be a step of simply preparing an amorphous alloy ribbon that has been previously produced.

The method of preparing an amorphous alloy ribbon may also include preparing a wound body of the resulting amorphous alloy ribbon.

An amorphous alloy ribbon can be produced by a known method, such as a liquid quenching method (e.g., a single roll method, a double roll method, or a centrifugal method).

Particularly, a single roll method, which is a production method that employs a relatively simple production equipment and can perform stable production, has excellent industrial productivity.

<Temperature-Increasing>

The method of producing an amorphous alloy ribbon according to the present disclosure includes a step of increasing a temperature of the amorphous alloy ribbon to a target maximum temperature that is in a range of from 410° C. to 480° C., at an average temperature increase rate of from 50° C./sec to less than 800° C./sec, in a state in which the amorphous alloy ribbon is tensioned with a tensile stress of from 20 MPa to 80 MPa.

In this step, a certain metal composition is selected, and the amorphous alloy ribbon is subject to temperature-increasing in a tensioned state while controlling the average temperature increase rate of the amorphous alloy ribbon to be lower than 800° C./sec with the target maximum temperature being from 410° C. to 480° C., whereby the degree of flatness can be improved.

In this step, the amorphous alloy ribbon may be thermal-treated by any method as long as the method is capable of increasing a temperature of the amorphous alloy ribbon to the above-described target maximum temperature with the average temperature increase rate being adjusted in the above-described range. When such a thermal treatment is performed, the amorphous alloy ribbon may be heated by bringing the amorphous alloy ribbon into contact with a heat transfer medium (which is a heat transfer medium for temperature-increasing in this step,) while allowing the amorphous alloy ribbon to travel in a tensioned state.

The phrase “travel in a tensioned state” used herein refers to a state where the amorphous alloy ribbon continuously travels with a tensile stress being applied thereto. The same applies to the temperature-decreasing step.

The tensile stress applied to the amorphous alloy ribbon is in a range of from 20 MPa to 80 MPa. With the tensile stress being in this range, the degree of flatness of the alloy ribbon is improved when the alloy ribbon is subject to temperature-increasing in contact with a heat transfer medium.

When the tensile stress is less than 20 MPa, the effect of improving the degree of flatness of the amorphous alloy ribbon is unlikely to be apparent. Meanwhile, when the tensile stress is higher than 80 MPa, there is a risk of breakage of the amorphous alloy ribbon during the thermal treatment, which is likely to make stable production difficult.

From the standpoint of further enhancing the effect of improving the degree of flatness of the amorphous alloy ribbon, the tensile stress is preferably 40 MPa or higher, and more preferably 45 MPa or higher. In addition, from the standpoint of further reducing the risk of breakage of the amorphous alloy ribbon during the thermal treatment, the tensile stress is preferably 70 MPa or less, and more preferably 60 MPa or less.

The tensile stress of the tensioned amorphous alloy ribbon, which is controlled by a travel control mechanism provided in an apparatus that allows the alloy ribbon to continuously travel (e.g., the below-described in-line annealing apparatus), is determined as a value obtained by dividing the tension controlled by the travel control mechanism by a cross-sectional area (width×thickness) of the alloy ribbon.

In this step, from the standpoints of enhancing the effect of improving the degree of flatness of the amorphous alloy ribbon and avoiding breakage of the alloy ribbon during the thermal treatment, it is preferable that the target maximum temperature is in a range of from 420° C. to 470° C. and the tensile stress is from 40 MPa to 70 MPa, and it is more preferable that the target maximum temperature is from 430° C. to 470° C. and the tensile stress is from 45 MPa to 60 MPa.

The average temperature increase rate is adjusted to be from 50° C./sec to less than 800° C./sec and, in this range, the average temperature increase rate is preferably from 60° C./sec to 760° C./sec, and more preferably from 300° C./sec to 500° C./sec.

The “average temperature increase rate” herein means a value obtained by dividing a difference between the temperature of the amorphous alloy ribbon prior to the temperature increasing (e.g., before the amorphous alloy ribbon is brought into contact with a heat transfer medium as described below) and the target maximum temperature of the amorphous alloy ribbon (=temperature of the heat transfer medium for temperature-increasing) by a duration (seconds) for which the amorphous alloy ribbon is in contact with the heat transfer medium.

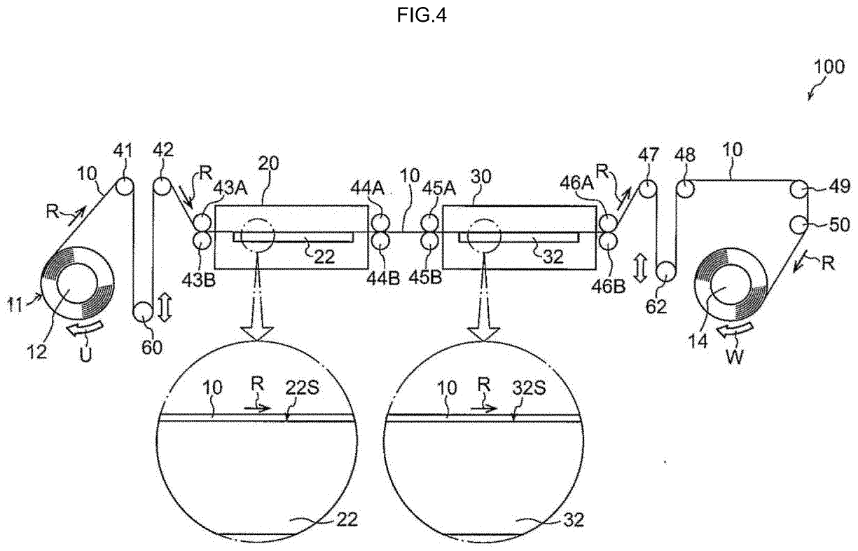

Specifically, for example, in a case of the in-line annealing apparatus illustrated in FIG. 4, the average temperature increase rate is determined by dividing a difference between the ribbon temperature measured using a radiation thermometer at 10 mm upstream of an inlet of a heating chamber 20 in the traveling direction of the amorphous alloy ribbon (the temperature of the amorphous alloy ribbon prior to the temperature increasing, which is generally a room temperature (from 20° C. to 30° C.)) and the temperature of a heat transfer medium for temperature-increasing (=target maximum temperature, e.g., 460° C.) by a duration (seconds) for which the amorphous alloy ribbon is in contact with the heat transfer medium for temperature-increasing. It is noted here that, when it is difficult to measure the ribbon temperature using a radiation thermometer at 10 mm upstream of the inlet of the heating chamber, or when the room temperature is unclear, the ribbon temperature can be set at 25° C.

The “in-line annealing apparatus” herein refers to, for example, an apparatus that, as illustrated in FIGS. 4 to 7, carries out an in-line annealing process in which the thermal treatment including the temperature-increasing and the temperature-decreasing (cooling) is continuously performed on an elongated amorphous alloy ribbon from an unwinding roll to a winding roll.

A temperature of the heat transfer medium for temperature-increasing is preferably adjusted to be from 410° C. to 480° C.

In this step, the amorphous alloy ribbon is heated to a target maximum temperature of from 410° C. to 480° C. By applying a tension to the amorphous alloy ribbon in this temperature range, a magnetic anisotropy can be provided in the longitudinal direction of the ribbon.

The target maximum temperature is the same as the temperature of the heat transfer medium for temperature-increasing.

The “temperature of the heat transfer medium for temperature-increasing” and the “target maximum temperature” are measured by a thermocouple arranged on the surface of the heat transfer medium for temperature-increasing with which the alloy ribbon comes into contact.

When the temperature of the heat transfer medium is 410° C. or higher, an effect of improving the degree of flatness, which is attributed to the application of a tensile stress, is likely to be obtained. When the temperature of the heat transfer medium is 480° C. or lower, acceleration of embrittlement of the amorphous alloy ribbon can be suppressed.

From the standpoint of enhancing the effect of improving the degree of flatness, the temperature of the heat transfer medium is preferably 420° C. or higher, more preferably 430° C. or higher, and particularly preferably 440° C. or higher. Meanwhile, from the standpoint of suppressing embrittlement of the amorphous alloy ribbon, the upper limit value of the temperature of the heat transfer medium is preferably 470° C. or lower.

In the temperature-increasing, a mode in which the amorphous alloy ribbon is suctioned from the side of the heat transfer medium to suppress a reduction in the contact area between the amorphous alloy ribbon and the heat transfer medium is preferable.

Specifically, the heat transfer medium has suction holes on its surface coming into contact with the amorphous alloy ribbon, and the amorphous alloy ribbon is vacuum-suctioned through the suction holes, whereby the amorphous alloy ribbon can be tightly adhered to the surface of the heat transfer medium. As a result, the amorphous alloy ribbon is reformed to have a more flattened shape, and the effect of improving the flatness of the amorphous alloy ribbon becomes prominent.

Moreover, in this step, after the temperature-increasing, the temperature of the amorphous alloy ribbon may be maintained for a certain period on the heat transfer medium.

The details of the heat transfer medium, the contact with the heat transfer medium and the conditions thereof, as well as the tensile stress applied during the heating and the like, are described below.

<Temperature-Decreasing>

Next, the method of producing an amorphous alloy ribbon according to the present disclosure includes the step of decreasing a temperature of the amorphous alloy ribbon, which has been heated in the above-described temperature-increasing, from the target maximum temperature to a temperature of a heat transfer medium for temperature-decreasing, at an average temperature decrease rate of from 120° C./sec to less than 600° C./sec.

This step may be performed by any method as long as the method is capable of decreasing a temperature of the amorphous alloy ribbon to the temperature of the heat transfer medium for temperature-decreasing with the average temperature decrease rate being adjusted in the above-described range.

In a treatment for the temperature-decreasing, a temperature of the amorphous alloy ribbon may be decreased by bringing the amorphous alloy ribbon into contact with a heat transfer medium (a heat transfer medium for temperature-decreasing in this step) while allowing the amorphous alloy ribbon to travel in a tensioned state.

The tensile stress applied to the amorphous alloy ribbon is, as in the temperature-increasing, in a range of from 20 MPa to 80 MPa. With the tensile stress being in this range, when the alloy ribbon is subject to temperature-decreasing, the degree of flatness of the alloy ribbon can be favorably maintained without markedly deteriorating the degree of flatness of the alloy ribbon that has been improved during the temperature-increasing.

When the tensile stress is less than 20 MPa, the effect of improving the degree of flatness of the amorphous alloy ribbon is unlikely to be apparent. Meanwhile, when the tensile stress is higher than 80 MPa, there is a risk of breakage of the amorphous alloy ribbon, which is likely to make stable production difficult.

From the standpoint of further enhancing the effect of improving the degree of flatness of the amorphous alloy ribbon, the tensile stress is preferably 40 MPa or higher, and more preferably 45 MPa or higher. In addition, from the standpoint of further reducing the risk of breakage of the amorphous alloy ribbon during the thermal treatment, the tensile stress is preferably 70 MPa or less, and more preferably 60 MPa or less.

As described above, the tensile stress of the tensioned amorphous alloy ribbon, which is controlled by a travel control mechanism provided in an apparatus that allows the alloy ribbon to continuously travel (e.g., the below-described in-line annealing apparatus), is determined as a value obtained by dividing the tension controlled by the travel control mechanism by a cross-sectional area (width×thickness) of the alloy ribbon.

The temperature of the heat transfer medium for temperature-decreasing is preferably in a range of 200° C. or lower.

The “temperature of the heat transfer medium for temperature-decreasing” herein refers to the temperature to which the temperature of the amorphous alloy ribbon is decreased in this step, and may be set as appropriate to be, for example, 200° C., 150° C., 100° C., or a room temperature (e.g., 20° C.).

The “temperature of the heat transfer medium for temperature-decreasing” is a temperature measured by a thermocouple arranged on a surface of the heat transfer medium for temperature-increasing that comes into contact with the alloy ribbon.

In the method of producing an amorphous alloy ribbon according to the present disclosure, a certain composition is selected and the temperature-increasing is performed as described above, after which the temperature of the amorphous alloy ribbon is decreased while controlling the average temperature decrease rate to be lower than 600° C./sec. By this, the flatness of the amorphous alloy ribbon improved in the temperature-increasing can both be maintained.

The average temperature decrease rate is an average rate at which a temperature of the amorphous alloy ribbon is decreased from the target maximum temperature to the temperature of the heat transfer medium for temperature-decreasing. For the same reasons as described above, the average temperature decrease rate is lower than 600° C./sec, and the upper limit value is preferably 500° C./sec, more preferably 400° C./sec, still more preferably 300° C./sec. Meanwhile, the average temperature decrease rate on the lower limit side is preferably 190° C./sec or higher, and the lower limit value is more preferably 200° C./sec.

Particularly, the average temperature decrease rate is preferably from 190° C./sec to 500° C./sec.

The “average temperature decrease rate” herein means a value obtained by, for example, dividing a difference between the target maximum temperature of the amorphous alloy ribbon (=the temperature of the heat transfer medium for temperature-increasing) and the temperature of the heat transfer medium for temperature-decreasing by a duration (seconds) from a point when the amorphous alloy ribbon leaves the heat transfer medium for temperature-increasing to a point when the amorphous alloy ribbon leaves the heat transfer medium for temperature-decreasing when the temperature of the amorphous alloy ribbon is decreased from the target maximum temperature to the temperature of the heat transfer medium for temperature-decreasing. Specifically, for example, in the case of the in-line annealing apparatus illustrated in FIG. 4, the average temperature decrease rate is determined by dividing a difference between the temperature of the heat transfer medium for temperature-increasing (heating plate 22 in FIG. 4) (=target maximum temperature) and the temperature of the heat transfer medium for temperature-decreasing (cooling plate 32 in FIG. 4) in the traveling direction of the amorphous alloy ribbon by a duration (seconds) from a point when the amorphous alloy ribbon leaves the heat transfer medium for temperature-increasing to a point when the amorphous alloy ribbon leaves the heat transfer medium for temperature-decreasing.

In this case, the in-line annealing apparatus has a single cooling chamber; however, when the in-line annealing apparatus includes plural cooling chambers that are connected to one another (the most upstream cooling chamber may be hereinafter referred to as “first cooling chamber”, and cooling chambers on the downstream of the first cooling chamber may be hereinafter referred to as “second cooling chamber” and the like), the average temperature decrease rate is defined as an average temperature decrease rate in the (first) cooling chamber arranged on the most upstream side in the traveling direction of the amorphous alloy ribbon (a value obtained by dividing a difference between the target maximum temperature and the temperature of a first heat transfer medium for temperature-decreasing by a duration (seconds) from a point when the amorphous alloy ribbon leaves the heat transfer medium for temperature-increasing to a point when the amorphous alloy ribbon leaves the first heat transfer medium for temperature-decreasing).

Examples of the heat transfer media that are used in the above-described temperature-increasing and temperature-decreasing include plates and twin rolls.

Examples of the materials of the heat transfer media include copper, copper alloys (e.g., bronze and brass), aluminum, iron, and iron alloys (e.g., stainless steel). Thereamong, copper, a copper alloy or aluminum is preferable because of its high thermal conductivity coefficient (heat transfer coefficient).

A plating treatment, such as Ni plating or Ag plating, may be performed on the heat transfer media.

A method for the cooling may be one in that the alloy ribbon is cooled by exposure to the air after being removed from the heat transfer medium for temperature-increasing; however, from the standpoint of controlling the temperature-decreasing rate, it is preferable to force-cool the alloy ribbon using a cooler. The cooler may be a noncontact-type cooler which cools the ribbon by blowing cold air thereto, or may be a contact-type cooler, which is a heat transfer medium the temperature of which is lowered and to, for example, 200° C. or lower and which is made to contact with the ribbon to decrease a temperature of the ribbon. The heat transfer medium may have suction holes on the surface coming into contact with the ribbon, and the ribbon may be vacuum-suctioned through the suction holes and thereby adsorbed onto the heat transfer medium surface having the suction holes.

As a result, the flattness of the amorphous alloy ribbon which is improved in the temperature-increasing is effectively maintained in the temperature-decreasing.

When a heat transfer medium is used for temperature-decreasing, it is preferable that the alloy ribbon heated in the temperature-increasing is removed from the heat transfer medium used in the temperature-increasing and then the temperature of the alloy ribbon is decreased. In this case, the cooler may be a noncontact-type cooler that cools the ribbon by blowing a cold air thereto. From the standpoint of the temperature-decreasing rate of the alloy ribbon, an embodiment of using a contact-type cooler that is a heat transfer medium which lowers its temperature to 100° C. or lower to cool the alloy ribbon in contact with the heat transfer medium is preferable. As the heat transfer medium, a heat transfer medium which is similar to one that can be used in the temperature-increasing may be employed.

In an embodiment of using a heat transfer medium to decrease the temperature of the alloy ribbon to the temperature of the heat transfer medium for temperature-decreasing by making the alloy ribbon to be in contact with the heat transfer medium, it is easy to perform the temperature-decreasing continuously from the temperature-increasing. The alloy ribbon is brought into contact with the heat transfer medium such that the average temperature decrease rate from the target maximum temperature in the temperature-increasing to the temperature of the heat transfer medium for temperature-decreasing is from 120° C./sec to less than 600° C./sec.

It is preferable that the surface of the heat transfer medium for temperature-increasing (e.g., a heating plate) coming into contact with the alloy ribbon is flat.

It is also preferable that the surface of the heat transfer medium for temperature-decreasing (e.g., a cooling plate) coming into contact with the alloy ribbon is flat.

More preferably, the surface of the heat transfer medium for temperature-increasing (e.g., a heating plate) coming into contact with the alloy ribbon and the surface of the heat transfer medium for temperature-decreasing (e.g., a cooling plate) coming into contact with the alloy ribbon are arranged in the same plane. This further makes it easier to perform the temperature-decreasing continuously from the temperature-increasing, so that the degree of flatness of the alloy ribbon can be effectively improved and maintained.

The method of producing an amorphous alloy ribbon according to the present disclosure is preferably carried out using the in-line annealing apparatus illustrated in FIGS. 4 to 7, which includes a heating chamber and a cooling chamber.

As illustrated in FIG. 4, an in-line annealing apparatus 100 includes: an unwinding roller 12 (an unwinding unit) which unwinds an alloy ribbon 10 from an alloy ribbon wound body 11; a heating plate (heat transfer medium) 22 which heats the alloy ribbon 10 unwound from the unwinding roller 12; a cooling plate (heat transfer medium) 32 which cools the alloy ribbon 10 heated by the heating plate 22; and a winding roller 14 (winding unit) which winds up the alloy ribbon 10 a temperature of which is decreased by the cooling plate 32. In FIG. 4, the traveling direction of the alloy ribbon 10 is indicated by an arrow R.

The alloy ribbon wound body 11 is set on the unwinding roller 12.

The unwinding roller 12 axially rotates in the direction of an arrow U, whereby the alloy ribbon 10 is unwound from the alloy ribbon wound body 11.

In this example, the unwinding roller 12 may include a rotating mechanism (e.g., a motor) by itself; however, the unwinding roller 12 does not necessarily include a rotating mechanism.

Even when the unwinding roller 12 does not include a rotating mechanism by itself, the alloy ribbon 10 is unwound from the alloy ribbon wound body 11 set on the unwinding roller 12 in conjunction with the below-described actions of the winding roller 14 to wind up the alloy ribbon 10.

In FIG. 4, as illustrated in an enlarged circular part, the heating plate 22 includes a first flat surface 22S with which the alloy ribbon 10 unwound from the unwinding roller 12 travels in contact. This heating plate 22 heats the alloy ribbon 10 traveling on the first flat surface 22S in contact therewith, through the first flat surface 22S. By this, the traveling alloy ribbon 10 is stably and rapidly heated.

The heating plate 22 is connected to a heat source (not illustrated) and heated to a desired temperature by the heat supplied from this heat source. Instead of or in addition to being connected to the heat source, the heating plate 22 may include a heat source inside the heating plate 22 by itself.

Examples of the material of the heating plate 22 include stainless steel, Cu, Cu alloys, and Al alloys.

The heating plate 22 is housed in the heating chamber 20.

The heating chamber 20 may also include a heat source for controlling the temperature of the heating chamber, separately from the heat source for the heating plate 22.

The heating chamber 20 has openings (not illustrated) through which the alloy ribbon 10 enters or exits on each of the upstream side and the downstream side of the traveling direction (arrow R) of the alloy ribbon 10. The alloy ribbon 10 enters the heating chamber 20 through an inlet that is the opening on the upstream side, and exits the heating chamber 20 through an outlet that is the opening on the downstream side.

Further, in FIG. 4, as illustrated in another enlarged circular part, the cooling plate 32 includes a second flat surface 32S with which the alloy ribbon 10 travels in contact. This cooling plate 32 cools the alloy ribbon 10 traveling on the second flat surface 32S in contact therewith, through the second flat surface 32S.

The cooling plate 32 may include a cooling mechanism (e.g., a water cooling mechanism); however, the cooling plate 32 does not necessarily include a particular cooling mechanism.

Examples of the material of the cooling plate 32 include stainless steel, Cu, Cu alloys, and Al alloys.

The cooling plate 32 is housed in the cooling chamber 30.

The cooling chamber 30 may include a cooling mechanism (e.g., a water cooling mechanism); however, the cooling chamber 30 does not necessarily include a particular cooling mechanism. In other words, the mode of the cooling performed by the cooling chamber 30 may be water cooling or air cooling.

The cooling chamber 30 has openings (not illustrated) through which the alloy ribbon 10 enters or exits on each of the upstream side and the downstream side of the traveling direction (arrow R) of the alloy ribbon 10. The alloy ribbon 10 enters the cooling chamber 30 through an inlet that is the opening on the upstream side, and exits the cooling chamber 30 through an outlet that is the opening on the downstream side.

The winding roller 14 is equipped with a rotating mechanism (e.g., a motor) that axially rotates in the direction of an arrow W. By the rotation of the winding roller 14, the alloy ribbon 10 is wound up at a desired rate.

The in-line annealing apparatus 100 further includes, between the unwinding roller 12 and the heating chamber 20 and along the travel route of the alloy ribbon 10: a guide roller 41; a dancer roller 60 (a tensile stress adjuster); a guide roller 42; and a pair of guide rollers 43A and 43B. The tensile stress is also adjusted by controlling the actions of the unwinding roller 12 and the winding roller 14.

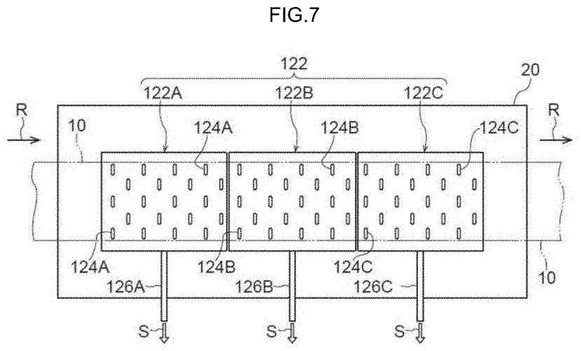

The dancer roller 60 is arranged in a movable manner along the vertical direction (the direction indicated by a double arrow in FIG. 7). The tensile stress of the alloy ribbon 10 can be adjusted by adjusting the position of this dancer roller 60 in the vertical direction.

The same applies to a dancer roller 62.

The alloy ribbon 10 unwound from the unwinding roller 12 is guided into the heating chamber 20 via these guide rollers and dancer roller.

The in-line annealing apparatus 100 further includes, between the heating chamber 20 and the cooling chamber 30: a pair of guide rollers 44A and 44B; and a pair of guide rollers 45A and 45B.

The alloy ribbon 10 exiting the heating chamber 20 is guided into the cooling chamber 30 via these guide rollers.

The in-line annealing apparatus 100 further includes, between the cooling chamber 30 and the winding roller 14 and along the travel route of the alloy ribbon 10: a pair of guide rollers 46A and 46B; a guide roller 47; a dancer roller 62; a guide roller 48; a guide roller 49; and a guide roller 50.

The dancer roller 62 is arranged in a movable manner along the vertical direction (direction indicated by a double arrow in FIG. 7). The tensile stress of the alloy ribbon 10 can be adjusted by adjusting the position of this dancer roller 62 in the vertical direction.

The alloy ribbon 10 exiting the cooling chamber 30 is guided to the winding roller 14 via these guide rollers and dancer roller.

In the in-line annealing apparatus 100, the guide rollers arranged on the upstream side and the downstream side of the heating chamber 20 have a function of adjusting the position of the alloy ribbon 10 so as to bring the alloy ribbon 10 into contact with the entirety of the first flat surface of the heating plate 22.

In the in-line annealing apparatus 100, the guide rollers arranged on the upstream side and the downstream side of the cooling chamber 30 have a function of adjusting the position of the alloy ribbon 10 so as to bring the alloy ribbon 10 into contact with the entirety of the second flat surface of the cooling plate 32.

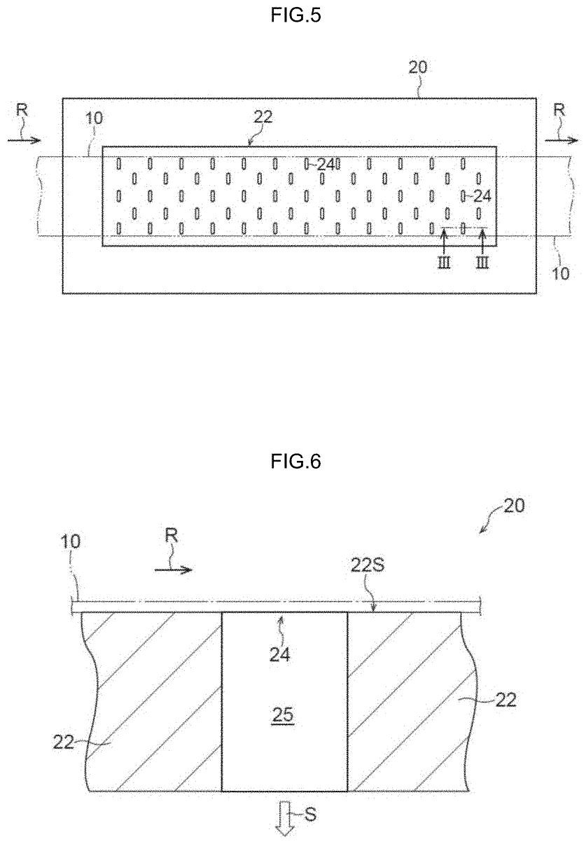

FIG. 5 is a schematic plan view illustrating the heating plate 22 of the in-line annealing apparatus 100 illustrated in FIG. 4, and FIG. 6 is a cross-sectional view taken along a line III-III of FIG. 5.

As illustrated in FIGS. 5 and 6, on the first flat surface of the heating plate 22 (i.e. the surface coming into contact with the alloy ribbon 10), plural openings 24 (suction structure) are formed. The openings 24 each constitute one end of a through-hole 25 penetrating through the heating plate 22.

In this example, the plural openings 24 are arranged two-dimensionally over the entire region coming into contact with the alloy ribbon 10.

A concrete arrangement of the plural openings 24 is not restricted to the one illustrated in FIG. 5. As illustrated in FIG. 5, the plural openings 24 are preferably arranged two-dimensionally over the entire region coming into contact with the alloy ribbon 10.

Further, the shape of each opening 24 is an elongated shape having a parallel section (two parallel sides). The lengthwise direction of each opening 24 is the direction perpendicular to the traveling direction of the alloy ribbon 10.

The shape of each opening 24 is not restricted to the one illustrated in FIG. 5, and various shapes other than the shape illustrated in FIG. 5, such as elongated shapes, elliptical shapes (including circular shapes), polygonal shapes (e.g., rectangular shapes) can be adopted.

Further, instead of or in addition to the opening, a groove may be provided as the suction structure as described.

In the in-line annealing apparatus 100, by removing the air from the internal spaces of the through-holes 25 (see an arrow S) using a suction device (not illustrated; e.g., a vacuum pump), the traveling alloy ribbon 10 can be suctioned onto the first flat surface 22S of the heating plate 22 on which the openings 24 are arranged. As a result, the traveling alloy ribbon 10 can be more stably brought into contact with the first flat surface 22S of the heating plate 22.

In this example, the through-holes 25 each penetrate through the heating plate 22 from the first flat surface 22S to a flat surface on the opposite side of the first flat surface 22S.

The through-holes may penetrate from the first flat surface 22S to a side surface of the heating plate 22.

FIG. 7 is a schematic plan view illustrating a modification example of the heating plate used in the present embodiment (heating plate 122).

As illustrated in FIG. 7, in this modification example, the heating plate 122 is divided into three regions (regions 122A to 122C) along the traveling direction (arrow R) of the alloy ribbon 10.

In the regions 122A to 122C, in the same manner as in the heating plate 22 illustrated in FIG. 5, plural openings 124A, 124B and 124C are arranged, respectively, in a two-dimensional manner over the entirety of each region coming into contact with the alloy ribbon 10. The openings 124A, 124B and 124C each constitute one end of a through-hole penetrating through the heating plate 122 and, to the plural through-holes of these regions, exhaust pipes 126A, 126B and 126C, which are in communication with the respective plural through-holes, are attached. Further, by removing the air from the internal spaces of the through-holes (see an arrow S) through these exhaust pipes 126A, 126B and 126C using a suction device (not illustrated; e.g., a vacuum pump), the traveling alloy ribbon 10 can be suctioned onto the first flat surface of the heating plate 122 on which the openings 124A, 124B and 124C are arranged.

—Preferable Mode of Temperature-Increasing and Temperature-Decreasing—

One preferable mode of the temperature-increasing and the temperature-decreasing is, for example, a mode in which, using an in-line annealing apparatus equipped with heat transfer media, an amorphous alloy ribbon is produced by thermal-treating an alloy ribbon by bringing the alloy ribbon into contact with a heat transfer medium for temperature-increasing and a heat transfer medium for temperature-decreasing, surfaces of which coming into contact with the alloy ribbon are positioned in the same plane, while applying a tension to the alloy ribbon (this mode is hereinafter referred to as “mode X”).

In the method of producing an amorphous alloy ribbon of the present disclosure, an amorphous alloy ribbon having a composition represented by the following Compositional Formula (A) is produced by way of the temperature-increasing and temperature-decreasing.

Fe_{100-a-b}BₐSi_{b}C_{c} Compositional Formula (A):

In Compositional Formula (A), a and b each represent an atomic fraction in the composition and satisfy the following respective ranges, and c represents an atomic fraction of C with respect to a total of 100.0 atom % of Fe, Si and B, and satisfies the following range:

13.0 atom %≤a≤16.0 atom %,

2.5 atom %≤b≤5.0 atom %,

0.20 atom %≤c≤0.35 atom %, and

79.0 atom %≤(100−a−b)≤83.0 atom %.

The amorphous alloy ribbon according to the present disclosure has an excellent flatness at its surface (main surface) since a specific tensile stress is applied thereto when subject to the temperature-increasing and temperature-decreasing. In addition, the amorphous alloy ribbon of the present disclosure exhibits an excellent flatness improving effect as it has the composition represented by Formula (A).

The above-described Compositional Formula (A) will now be described in more detail.

In Compositional Formula (A), the atomic fraction (atom %) of Fe is determined as “100−a−b”. Fe, which is a main component of the amorphous alloy ribbon, is a primary element that determines the magnetic properties.

The “100−a−b” representing the content ratio of Fe may include, for example, unavoidable impurities containing at least one element selected from the group consisting of Nb, Mo, V, W, Mn, Cr, Cu, P, and S. The content of the unavoidable impurities is preferably in a range of 1 atom % or less.

The amorphous alloy ribbon of the present disclosure is an Fe-based amorphous alloy ribbon that contains not less than 79.0 atom % [=(100−a−b)=(100−16.0−5.0)] of Fe (including unavoidable impurities). By allowing the alloy composition to have a relatively high Fe content ratio, the effect of improving flattness can be obtained more effectively.

The value of “100−a−b” is preferably 79.0 or larger, more preferably 80.5 or larger, and still more preferably 81.0 or larger.

The upper limit value of “100−a−b” (atom %), which is determined in accordance with a and b, is 83.0 or smaller.

In the above-described range, the content ratio “100−a−b” preferably satisfies the following range:

80.5 atom %≤100−a−b≤83.0 atom %.

In Compositional Formula (A), the atomic fraction a of B is from 13.0 atom % to 16.0 atom %. In the amorphous alloy ribbon, B has a function of stably maintaining an amorphous state.

In the present disclosure, B effectively exhibits this function with its atomic fraction a being 13.0 atom % or higher. In addition, since the atomic fraction a of 16.0 atom % or lower ensures the Fe content, the saturation magnetic flux density Bₛ of the amorphous alloy ribbon and that of the amorphous alloy ribbon piece can be improved, leading to an increased B₈₀.

Particularly, the atomic fraction a of B preferably satisfies the following range:

14.0 atom %≤a≤16.0 atom %.

In Compositional Formula (A), the atomic fraction b of Si is from 2.5 atom % to 5.0 atom %.

Si has functions of increasing a crystallization temperature of the amorphous alloy ribbon and forming a surface oxide film.

In the present disclosure, Si effectively exhibits these functions with the atomic fraction b being 2.5 atom % or higher. Accordingly, the thermal treatment can be performed at a higher temperature. In addition, since the atomic fraction b of 5.0 atom % or lower ensures the Fe content, the saturation magnetic flux density B. of the amorphous alloy ribbon is improved.

The atomic fraction b of Si preferably satisfies the following range:

3.0 atom %≤b≤4.5 atom %.

In Compositional Formula (A), the atomic fraction c of C is from 0.20 atom % to 0.35 atom %. By incorporating C (carbon) into the composition of the Fe—B—Si-based amorphous alloy ribbon, the space factor of the alloy ribbon is improved. The reason for this is believed to be because the effect of improving the surface flatness of the alloy ribbon is further enhanced by an addition of C at the above-described range. When c is smaller than 0.20 atom %, the improvement of the alloy ribbon surface becomes insufficient. When c is greater than 0.35 atom %, there may be a tendency that embrittlement of the alloy ribbon in the thermal treatment becomes remarkable.

The atomic fraction c of C is preferably in a range of from 0.23 atom % to 0.30 atom %.

The amorphous alloy ribbon of the present disclosure has favorable magnetic flux densities and coercivity as its magnetic properties.

The amorphous alloy ribbon of the present disclosure has high magnetic flux densities (B₈₀ and B₈₀₀). The B₈₀ is the magnetic flux density that is measured when the amorphous alloy ribbon is magnetized in a magnetic field of 80 A/m, and the B₈₀₀ is the magnetic flux density that is measured when the amorphous alloy ribbon is magnetized in a magnetic field of 800 A/m.

The magnetic flux density B₈₀ of the amorphous alloy ribbon of the present disclosure is preferably 1.45 T or higher. Particularly, when the magnetic flux density B₈₀ is 1.50 T or higher, various soft magnetic application components can be obtained using a core produced from the amorphous alloy ribbon.

In the amorphous alloy ribbon of the present disclosure, the coercivity (Hₑ) is controlled to be low.

The coercivity is preferably 1.0 A/m or less, and more preferably 0.8 A/m or less. When the coercivity is 1.0 A/m or less, the hysteresis loss is reduced, so that a core produced from the amorphous alloy ribbon has a low iron loss.

The magnetic flux densities (B₈₀ and B₈₀₀) and the coercivity (Hₑ) are values determined using a direct-current magnetization analyzer SK110 (manufactured by METRON, Inc.).

The B₈₀ is a value measured using the direct-current magnetization analyzer SK110 at a magnetic field intensity of 80 A/m, and the B₈₀ is a value measured using the direct-current magnetization analyzer SK110 at a magnetic field intensity of 800 A/m.

The coercivity (Hₑ) is a value determined from a hysteresis curve measured at a magnetic field intensity of 800 A/m.

<Amorphous Alloy Ribbon>

An amorphous alloy ribbon of the present disclosure is one that has cuttability and including undulations at one widthwise end and at an opposite widthwise end, and has a height h and a width w which satisfy the following Equation (1), in which the height h is an average value of plural heights including: heights of protruding apexes of undulations disposed along a longitudinal direction at a position 10 mm away from, in an in-plane direction, the one widthwise edge of the amorphous alloy ribbon; and heights of protruding apexes of undulations disposed in the longitudinal direction at a position 10 mm away from, in the in-plane direction, the opposite widthwise edge of the amorphous alloy ribbon, and the width w is an average value of width of the undulations.

0.1≤100×h/w≤1.5 Equation (1):

A wound magnetic core of the present disclosure has cuttability. The expression of having “cuttability” used herein means that the amorphous alloy ribbon can be cut with scissors.

The cuttability serves as a first brittleness index that represents the degree of embrittlement of the amorphous alloy ribbon. Specifically, the cuttability is evaluated based on whether or not the alloy ribbon is substantially linearly divided and a non-linear broken part is 5% or less of the whole cut dimensions when the alloy ribbon is cut using a cutting tool that cuts an object by pinching it between two blades (e.g., scissors).

In the amorphous alloy ribbon of the present disclosure, generation of undulations of the undulating shapes (side waves or edge waves) appearing in the widthwise ends of the alloy ribbon is limited, and the degree of flatness representing the size of the undulations of the undulating shapes is controlled to be in a range of the following Equation (1). In other words, the degree of flatness of the amorphous alloy ribbon is determined by “100×h/w”.

0.1≤100×h/w≤1.5 Equation (1):

In the amorphous alloy ribbon of the present disclosure, when the degree of flatness (=100×h/w) is higher than 1.5, the undulating shapes in the widthwise ends of the alloy ribbon are excessively large and cause a problem in that they reduce the space factor. The degree of flatness (=100×h/w) is preferably as close to 0 (zero) as possible in terms of providing a uniform and flat surface. As a practical range, the degree of flatness may be 0.1 or higher.

From the standpoint of further improving the shape reproducibility in the core production and the space factor, the degree of flatness is preferably from 0.1 to 1.2, and more preferably from 0.1 to 1.0.

As described above, the degree of flatness can be adjusted by, in the production of an amorphous alloy ribbon, incorporating an operation of temperature-increasing or temperature-decreasing the amorphous alloy ribbon with a specific tensile stress being applied thereto in the temperature-increasing and the temperature-decreasing, and thereby controlling the degree of undulation generated in the vicinity of the edges of the resulting alloy ribbon.

The height h and the width w in Equation (1) will now be described.

Focusing on both the undulations of the undulating shapes existing at one widthwise end of the amorphous alloy ribbon (side waves) and the undulations of the undulating shapes existing at an opposite widthwise end of the amorphous alloy ribbon, the height h is determined as an average apex height of the undulations existing on both widthwise ends.

Specifically, the height h is expressed as an average value of plural heights that include: the height h is an average value of plural heights including: heights of protruding apexes of undulations disposed along a longitudinal direction perpendicular to a width direction, at a position 10 mm away from, in an in-plane direction, one widthwise edge of the amorphous alloy ribbon; and heights of protruding apexes of undulations of the plural undulating shapes disposed in the longitudinal direction at a position 10 mm away from, in the in-plane direction, an opposite widthwise edge of the amorphous alloy ribbon.

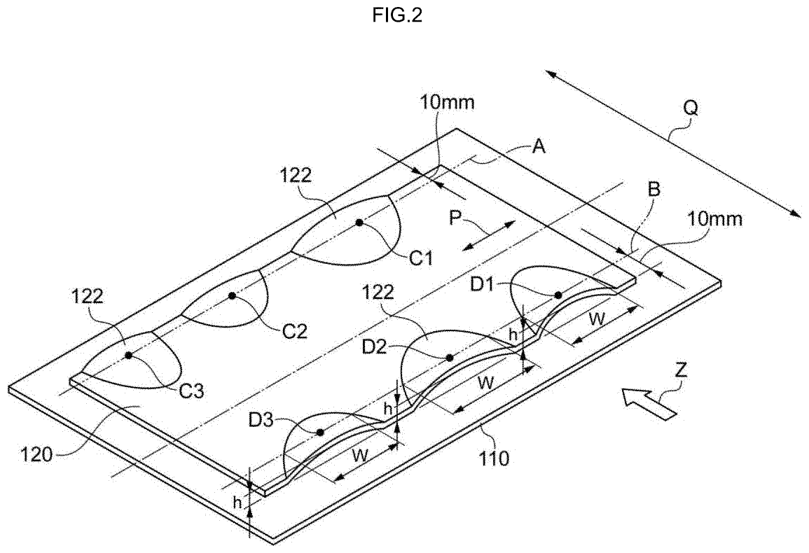

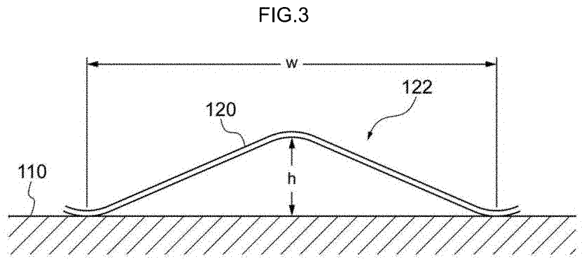

This will now be further described referring to FIGS. 2 and 3.

In an amorphous alloy ribbon, as illustrated in FIG. 2, plural undulating shapes (irregular shapes) undulating in the thickness direction of the alloy ribbon (the direction perpendicular to the main surface of the alloy ribbon) may be generated in the vicinity of the widthwise edges of the alloy ribbon. In this case, the width of the alloy ribbon is 142.2 mm.

FIG. 2, which is a schematic perspective view illustrating one example of undulating shapes formed in the vicinity of the widthwise edges of an amorphous alloy ribbon, shows a state where an amorphous alloy ribbon 120 is placed on a flat table (flat surface) 110.

In both of the edge portions in a width direction Q perpendicular to a longitudinal direction P of the amorphous alloy ribbon 120 illustrated in FIG. 2, irregular shapes undulating in the vertical direction of the flat table (flat surface) 110 (the direction perpendicular to the main surface of the alloy ribbon) are continuously formed along the longitudinal direction P.

In the present specification, such continuous plural irregular shapes may also be referred to as “plural amplitudes (shapes)”, “plural undulating shapes”, or “plural side wave shapes”.

As illustrated in FIGS. 2 and 3, the vicinity of the center of the alloy ribbon in the width direction Q is observed with no large undulation and is hardly affected by the undulations of the widthwise ends. Accordingly, it is believed that, in the widthwise central portion and edge portions of the alloy ribbon, the length of the alloy ribbon in the longitudinal direction is different between the widthwise ends and the central portion, with the length of the alloy ribbon being longer in the edge portions than in the central portion. The height h is expressed as an average of (m+n) number of height values that include: the heights h of protruding apexes C1, C2, C3 . . . of the plural undulations (side waves) 122 existing along the longitudinal direction P perpendicular to the width direction Q at the positions of 10 mm away from, in the in-plane direction, one edge of the amorphous alloy ribbon 120 in the width direction Q, i.e. at the positions on a chain double-dashed line A of FIG. 2 (in FIG. 2, h^{C1}, h^{C2}, h^{C3} . . . h^{Cm}); and the heights h of protruding apexes D1, D2, D3 . . . of the plural undulations 122 existing along the longitudinal direction P at the positions of 10 mm away from, in the in-plane direction, another edge of the amorphous alloy ribbon 120 in the width direction Q, i.e. at the positions on a chain double-dashed line B of FIG. 2 (in FIG. 2, h^{D1}, h^{D2}, h^{D3} . . . h^{Dn}), and the height h is determined by the following equation:

Height h={(h^{C1}+h^{C2}+h^{C3}+ . . . h^{Cm})+(h^{D1}+h^{D2}+h^{D3}+ . . . h^{Dn})}/(m+n).

The height h of the protruding apex in each undulation can be determined by continuously measuring the height along 10 mm inside of an edge of the alloy ribbon using a laser displacement meter and determining the maximum value of h in each period.

The width w of the undulations is expressed as an average value of widths of each period in the undulations.

For example, as illustrated in FIG. 3, the width w is the distance between recesses (bottom parts) sandwiching a protrusion (bulging part) having a height h of the protruding apex of each undulation 122.

The width w is a value that is determined by measuring the edges of the alloy ribbon using a laser displacement meter and calculating, from the thus measured values, the distance between the recesses that are formed between the apexes aligned along the longitudinal direction (i.e., the distance between the parts having the lowest height h).

The width w of the undulations is expressed as, for example, an average value of the widths of (m+n) number of undulations, which widths are measured for those undulations whose height h of the protruding apex has been measured among the undulations of the amorphous alloy ribbon 120 (in FIG. 2, w^{C1}, w^{C2}, w^{C3} . . . w^{Cm}, w^{D1}, w^{D2}, w^{D3} . . . w^{Dn}), and can be determined by the following equation.

In this equation, the “width w” represents the width of the undulations measured at the positions along the chain double-dashed line A or B of FIG. 2, including the respective protruding apexes C1, C2, C3 . . . and D1, D2, D3 . . . .

Width w={(w^{C1}+w^{C2}+w^{C3}+ . . . w^{Cm})+(w^{D1}+w^{D2}+w^{D3}+w^{Dn})}/(m+n)

In FIG. 2, all of the undulations schematically have a width of 1 (constant), and a flat portion exists in each recess between undulations; however, this is merely a schematic example, and the constitution is not restricted thereto. There are cases where the width is not constant, and cases where the recesses each have only a portion of the lowest height h without any flat portion.

The amorphous alloy ribbon preferably has a thickness of from 20 μm to 30 μm.

When the thickness is 20 μm or greater, the mechanical strength of the amorphous alloy ribbon is ensured, so that breakage of the amorphous alloy ribbon piece is suppressed.

The thickness of the amorphous alloy ribbon is more preferably 22 μm or greater.

Meanwhile, when the thickness is 30 μm or less, the amorphous alloy ribbon can attain a stable amorphous state after being cast.

The amorphous alloy ribbon has a width, which is perpendicular to the longitudinal direction, of preferably 20 mm or greater, and preferably 220 mm or less.

When the amorphous alloy ribbon has a width of 20 mm or greater, a core can be produced therefrom with good productivity. Meanwhile, when the amorphous alloy ribbon has a width of 220 mm or less, variations in the thickness and the magnetic properties along the width direction can be suppressed, so that a stable productivity is likely to be ensured.

### Examples

The invention will now be described more concretely by way of examples thereof; however, the invention is not restricted to the following examples as long as they do not depart from the gist of the invention.

<Production of Amorphous Alloy Ribbons>

By a liquid quenching method of ejecting a molten alloy onto an axially rotating temperature-decreasing roll, an amorphous alloy ribbon of 142 mm in width and 25 μm in thickness, which had a composition of Fe_{81.3}Si_{4.0}B_{14.7}C_{0.25} (atom %) was produced.

Next, using an in-line annealing apparatus including a heat transfer medium in a heating chamber, which apparatus was configured in the same manner as illustrated in FIG. 4, the thus obtained amorphous alloy ribbons were each, in a tensioned state, introduced into the heating chamber and brought into contact with the heat transfer medium to perform a thermal treatment in the above-described mode X. The thermal treatment was performed with the temperature of the heat transfer medium being changed in the below-described respective ranges. Then, the amorphous alloy ribbons were each introduced into a cooling chamber to decrease its temperature to 25° C. from a highest temperature reached during the temperature-increasing. The thus thermal-treated amorphous alloy ribbons were each subsequently allowed to exit the cooling chamber. Thereafter, the resulting amorphous alloy ribbons were each wound up to obtain wound bodies.

The production conditions were as follows.

### <Production Conditions>

Heat transfer media for temperature-increasing and temperature-decreasing: bronze plates

Target maximum temperature (temperature of heat transfer medium for temperature-increasing): from 350° C. to 500° C. (see Table 1 below)

Tensile stress applied to amorphous alloy ribbon: 50 MPa

Contact distance of amorphous alloy ribbon with heat transfer medium for temperature-increasing: 1.2 m

Contact time of amorphous alloy ribbon with heat transfer medium for temperature-increasing: 1.2 seconds

Duration from a point when amorphous alloy ribbon leaves heat transfer medium for temperature-increasing to a point when amorphous alloy ribbon leaves heat transfer medium for temperature-decreasing: 1.2 seconds

Average temperature increase rate and Average temperature decrease rate: see Table 1 below

The temperature of the heat transfer medium for temperature-increasing and that of the heat transfer medium for temperature-decreasing were measured by thermocouples arranged on the surfaces of the respective heat transfer media with which the alloy ribbon came into contact, and the average temperature increase rate and the average temperature decrease rate were calculated.

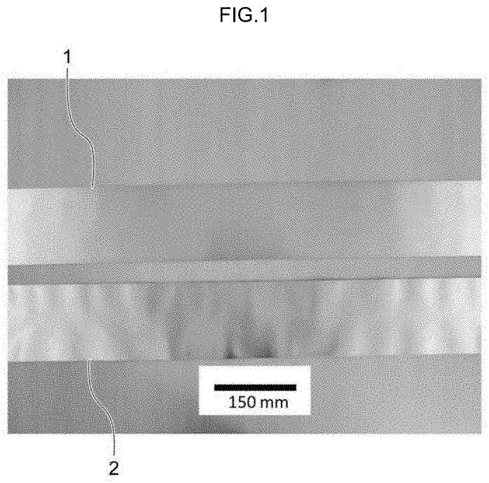

The average temperature increase rate was determined by dividing a difference between the temperature of the amorphous alloy ribbon, which was measured using a radiation thermometer at 10 mm upstream of the inlet of the heating chamber 20 in the traveling direction of the amorphous alloy ribbon (the ribbon temperature prior to heating=usually a room temperature, which was 25° C. in the present Examples), and the temperature of the heat transfer medium for temperature-increasing (heating plate 22 in FIG. 1) by a duration (seconds) for which the amorphous alloy ribbon was in contact with the heat transfer medium for temperature-increasing.

The average temperature decrease rate was determined by dividing a difference between the temperature of the heat transfer medium for temperature-increasing (heating plate 22 in FIG. 4) (=target maximum temperature) and the temperature of the heat transfer medium for temperature-decreasing (cooling plate 32 in FIG. 1; 25° C.) in the traveling direction of the amorphous alloy ribbon by a duration (seconds) from a point when the amorphous alloy ribbon left the heat transfer medium for temperature-increasing to a point when the amorphous alloy ribbon left the heat transfer medium for temperature-decreasing.

It is noted here that, in in-line annealing, the target maximum temperature of the amorphous alloy ribbon can be controlled by changing the temperature of the heat transfer media, and the average temperature increase rate and the average temperature decrease rate can be controlled thereby, when the traveling speed of the amorphous alloy ribbon is constant (e.g. when it is 0.5 m/sec). The average temperature increase rate can be controlled to be in a range of from 271° C./sec to 396° C./sec and the average temperature decrease rate can be controlled to be in a range of from 204° C./sec to 298° C./sec by changing the temperature of the heat transfer medium for temperature-increasing (which is the same as the target maximum temperature of amorphous alloy ribbon,) in a range of from 350° C. to 500° C.

<Production of Amorphous Alloy Ribbon Pieces>

Next, from a wound body of the amorphous alloy ribbon, the amorphous alloy ribbon was unwound, and an amorphous alloy ribbon piece having a longitudinal length of 1000 mm (1 m) was cut out from the thus unwound amorphous alloy ribbon. The cutting of the amorphous alloy ribbon was done by shirring.

<Measurement and Evaluation>

### —1. Degree of Flatness—

Each thermal-treated amorphous alloy ribbon was sampled at a longitudinal length of 1 m, and the thus sampled amorphous alloy ribbon of 1 m in length and 142 mm in width was placed on a surface plate. Then, at the positions of, along the width direction of the amorphous alloy ribbon, 10 mm from one edge in the in-plane direction and 10 mm from the other edge in the in-plane direction (i.e., on two straight lines positioned at 10 mm from the respective widthwise edges in the in-plane direction), the height (the height of the protruding apex in each undulation) was continuously measured at a resolution of 0.1 mm using a laser-type displacement sensor LB-300 and a multi-functional digital meter relay RV3-55R (both of which are manufactured by KEYENCE Corporation). An average of the thus measured values (heights of protruding apexes) was calculated as height h. It is noted here that variations in the thickness of each alloy ribbon can be ignored since the resolution was 0.1 mm.

Further, in the same manner as described above, the distance between the recesses formed between the protruding apexes of the undulations aligned along the longitudinal direction (i.e., the distance between portions having the lowest height h) was determined as width w.

The thus determined height h and width w were substituted into the following equation to calculate the degree of flatness:

Degree of flatness=100×h/w

—2. Cuttability—

Plural amorphous alloy ribbons, which were produced by changing the average temperature increase rate or the average temperature decrease rate and the target maximum temperature based on the temperatures of the heat transfer media, were each cut with stainless-steel scissors (product name: WESTCOTT 8″ All Purpose Preferred Stainless Steel Scissors, manufactured by Westcott). In this process, the presence or absence of cuttability was evaluated based on the following criteria.

### <Evaluation Criteria>

Present: The amorphous alloy ribbon was substantially linearly divided, with a non-linear broken part being not more than 5% of the whole cut dimensions.

Absent: A non-linear broken part was more than 5% of the whole cut dimension

TABLE 1

| | Average | Average | | | | | |
|---|---|---|---|---|---|---|---|
| Highest | temperature | temperature | | | Degree of | | |
| attained | increase | decrease | Side wave | Side wave | flatness | | |
| temperature | rate | rate | height h | width w | (100 × h/w) | | |
| [° C.] | [° C./sec] | [° C./sec] | [mm] | [mm] | [%] | Cuttability | Note |
| before | — | — | 1.8 | 72 | 2.5 | present | Comparative |
| thermal | | | | | | | Example |
| treatment | | | | | | | |
| 350 | 271 | 204 | 1.3 | 67 | 1.9 | present | Comparative |
| | | | | | | | Example |
| 380 | 296 | 222 | 1.1 | 63 | 1.7 | present | Comparative |
| | | | | | | | Example |
| 410 | 321 | 241 | 0.6 | 52 | 1.2 | present | Example |
| 420 | 329 | 247 | 0.5 | 46 | 1.1 | present | Example |
| 440 | 346 | 259 | 0.4 | 38 | 1.1 | present | Example |
| 460 | 363 | 272 | 0.2 | 20 | 1.0 | present | Example |
| 480 | 379 | 284 | 0.3 | 31 | 1.0 | present | Example |
| 500 | 396 | 298 | 0.3 | 28 | 1.1 | absent | Comparative |
| | | | | | | | Example |

As shown in Table 1, when the alloy ribbon not having been thermal-treated and the alloy ribbons thermal-treated at different target maximum temperatures were evaluated, it was found that, in Examples where the target maximum temperature during the thermal treatment was from 410° C. to 480° C., the alloy ribbons had a low degree of flatness of from 1.0 to 1.2, namely, an amount of undulating shapes appearing in series on the widthwise edges was suppressed to be small. In the alloy ribbons of Examples, as compared to the amorphous alloy ribbon 2 shown in FIG. 1 which had a non-flat shape and had not been thermal-treated, the undulating shapes (irregular shapes) were corrected and the degree of flatness was improved as in the amorphous alloy ribbon 1 shown in FIG. 1. The amorphous alloy ribbon 1 is the alloy ribbon shown in Table 1 which was treated with a target maximum temperature of 460° C., and it is seen that this alloy ribbon had an excellent degree of flatness, with the generation of undulating shapes being almost not visually observable.

It is noted here that FIG. 1 shows appearance photographs of the above-described amorphous alloy ribbons that were taken from the direction perpendicular to the main surface of each alloy ribbon.

Specifically, the alloy ribbon not having been thermal-treated had a high degree of flatness at 2.5 and was observed with undulating shapes in the vicinity of its widthwise edges. In addition, in Comparative Examples where the target maximum temperature was 350° C. or 380° C., the degree of flatness was high at 1.9 and 1.7, respectively, and it is thus seen that the shape-correcting effect by the thermal treatment was small.

Moreover, in Comparative Example where the target maximum temperature during the thermal treatment was 500° C., the degree of flatness was low at 1.1; however, cracking and breakage easily occurred when the alloy ribbon was cut, and the alloy ribbon had poor cuttability, with more than 20% thereof being not linearly cuttable.

The disclosure of U.S. Provisional Application No. 62/528,451 filed on Jul. 4, 2017 is incorporated herein by reference in its entirety.

All documents, patent applications, and technical standards described in the present specification are incorporated into the present specification to the same extent in a case where each individual document, patent application, and technical standard was specifically and individually indicated to be incorporated by reference.

1. A method of producing an amorphous alloy ribbon having a composition represented by the following Compositional Formula (A), the method comprising:
preparing an amorphous alloy ribbon having a composition consisting of Fe, Si, B, C, and unavoidable impurities;
increasing a temperature of the amorphous alloy ribbon to a target maximum temperature that is in a range of from 410° C. to 480° C., at an average temperature increase rate of from 50° C./sec to less than 800° C./sec, in a state in which the amorphous alloy ribbon is tensioned with a tensile stress of from 20 MPa to 80 MPa; and
decreasing a temperature of the thus heated amorphous alloy ribbon from the target maximum temperature to a temperature of a heat transfer medium for temperature-decreasing, at an average temperature decrease rate of from 120° C./sec to less than 600° C./sec, in a state in which the amorphous alloy ribbon is tensioned with a tensile stress of from 20 MPa to 80 MPa:
Fe_{100-a-b}BₐSi_{b}C_{c} Compositional Formula (A):
wherein, in Compositional Formula (A), a and b each represent an atomic fraction in the composition and satisfy the following respective ranges, and c represents an atomic fraction of C with respect to a total of 100.0 atom % of Fe, Si and B, and satisfies the following range:
13.0 atom %≤a≤16.0 atom %,
2.5 atom %≤b≤5.0 atom %,
0.20 atom %≤c≤0.35 atom %, and
79.0 atom %≤(100−a−b)≤83.0 atom %.

2. The method of producing an amorphous alloy ribbon according to claim 1, wherein the average temperature increase rate is from 60° C./sec to 760° C./sec, and the average temperature decrease rate is from 190° C./sec to 500° C./sec.

3. The method of producing an amorphous alloy ribbon according to claim 1, wherein the tensile stress is from 40 MPa to 70 MPa.

4. The method of producing an amorphous alloy ribbon according to claim 1, wherein the (100−a−b) satisfies the following range:
80.5 atom %≤(100−a−b)≤83.0 atom %.

5. The method of producing an amorphous alloy ribbon according to claim 1, wherein the increase of temperature in the temperature increasing and the decrease of a temperature in the temperature decreasing is performed by allowing the amorphous alloy ribbon to travel in a tensioned state and bringing the amorphous alloy ribbon that is traveling into contact with a heat transfer medium.

6. The method of producing an amorphous alloy ribbon according to claim 5, wherein a contact surface of the heat transfer medium that increases the temperature of the amorphous alloy ribbon that is traveling and a contact surface of the heat transfer medium that decreases the temperature of the amorphous alloy ribbon that is traveling are arranged in a flat plane.

7. An amorphous alloy ribbon, comprising undulations at one widthwise end and at an opposite widthwise end, wherein a height h and a width w satisfy the following Equation (1):
0.1≤100×h/w≤1.5 Equation (1):
wherein the height h is an average value of plural heights including: heights of protruding apexes of undulations disposed at a position to mm away from, in an in-plane direction, the one widthwise edge of the amorphous alloy ribbon; and heights of protruding apexes of undulations disposed at a position to mm away from, in the in-plane direction, the opposite widthwise edge of the amorphous alloy ribbon, and
the width w is an average value of width of the undulations.
